(19) United States
(12) Patent Application Publication
(10) Pub. No.: US 2014/0217732 A1
(43) Pub. Date: Aug. 7, 2014

(54) SMALL TURBINES IN WATER RECLAMATION FACILITIES FOR GENERATION OF ELECTRICITY

(71) Applicant: Seymour R. Levin, Los Angeles, CA (US)

(72) Inventor: Seymour R. Levin, Los Angeles, CA (US)

(21) Appl. No.: 14/251,529

(22) Filed: Apr. 11, 2014

Related U.S. Application Data
(63) Continuation-in-part of application No. 13/654,333, filed on Oct. 17, 2012.
(60) Provisional application No. 61/549,100, filed on Oct. 19, 2011.

(51) Int. Cl. H02K 7/18

(52) U.S. Cl. CPC H02K 7/1823
USPC 290/52

(57) ABSTRACT

Turbine assemblies including small turbines coupled to generators are sequentially located in a fast-flowing treatment channel of a water reclamation facility. Each turbine assembly may include a vertical turbine shaft mounted on a brace suspended above water level, with the turbine blades submerged in the flow. The distal end of the vertical turbine shaft may be free (unattached) to the bottom or to any other part of the channel, and may be supported by two or more bearings mounted to the brace. The brace may be generally horizontal and may span the channel and be anchored to opposing walls thereof. An encased generator may be located in an air space between the water level and a removable cover. Power may be collected from the generators via insulated wiring incorporated into a main power cable for distribution to an energy consumption source.

### CROSS-REFERENCE TO RELATED APPLICATION

This application is a continuation-in-part of U.S. application Ser. No. 13/654,333 filed Oct. 17, 2012, which claims priority under 35 U.S.C. §119(e) to U.S. Application Ser. No. 61/549,100, filed Oct. 19, 2011, the entirety of which applications are incorporated herein by reference.

### BACKGROUND OF THE INVENTION

1. Field

The present disclosure relates to small turbines in water reclamation facilities for generation of electricity.

2. Background

Energy, particularly in the United States, is primarily derived from non-renewable energy sources. Oil, coal, and natural gas, for example, are some non-renewable energy sources, which are being depleted to provide communities around the world with electrical power. Although alternatives to non-renewable energy sources exist, they are underutilized. In the United States, for example, less than 10% of the total U.S. electricity production is derived from renewable energy sources. (2009 Annual Energy Review, U.S. Energy Information Admin., August, 2010).

Use of some non-renewable energy sources can also cause significant environmental issues. As a result, many countries have increased their efforts to reduce emission of pollutants and consumption of nonrenewable sources. Many countries, therefore, continue to seek renewable and environmentally friendly sources of energy.

Renewable energy sources generally can be classified into two groups: continuous and intermittent sources of energy. Wind and solar energy are primarily intermittent. Thus, power plants, relying on wind and/or solar energy are literally at the mercy of nature. Because these sources are unpredictable, they are frequently used alongside non-renewable energy sources. In some cases, power plants, which primarily use non-renewable sources of energy, are able to reduce or idle their power production through use of wind and solar power. Nonetheless, implementing wind and solar power in this manner is still not cost-effective and over time may increase overall production costs.

In contrast, geothermal and hydrodynamic energy sources can be harnessed for continuous energy production. Geothermal energy, at least in the United States, is currently derived from just few areas. Unfortunately, these sources of geothermal energy merely produce less than one half of one percent of electricity in the United States.

Hydrodynamic energy is available from a significant number of sources—both natural and man-made. Traditionally, large scale reservoirs, which are elevated in excess of 100 feet, are used to generate large quantities of electricity at various locations. Dams and waterfalls may also be used to provide the necessary head to turn water turbines. Unfortunately, large scale reservoirs require significant capital costs and alter ecosystems of surrounding areas.

It would be desirable, therefore, to provide methods and systems for generation and use of energy from alternative sources, that overcome the limitations and disadvantages as summarized above.

### SUMMARY

Gravity-fed sewage systems may be prospective sources of hydropower, but are generally ignored or dismissed as useful power sources due to various problems. For example, low or variable flow speeds and water levels, high levels of sludge and debris, and biohazards associated with installation and maintenance may rule out many sewage hydropower projects, and create a tendency to disfavor such projects in general. The tendency to disfavor hydropower from sewage installations may cause economically feasible proposals to be overlooked or rejected. Accordingly, otherwise feasible opportunities for recovery of hydropower from sewage systems may have previously gone unrecognized.

For example, recovery of energy from hydropower within the wastewater treatment facility itself may entail few or none of the problems associated with power recovery at other locations of a sewer system. At treatment facilities, flow from tributaries of the sewer system is aggregated. Hence, the volume of flow may be large enough that normal variations in sewage flow do not fall outside of the operating requirements for small turbines. Moreover, downstream of primary treatment systems, sludge and debris are virtually eliminated, and biohazards substantially reduced, as the function of sewage treatment transitions to the purpose of water reclamation. At the same time, significant recoverable head may remain in the effluent stream downstream of primary treatment.

Accordingly, turbine assemblies including small turbines coupled to generators are sequentially located in a fast-flowing treatment channel of a water reclamation facility. Each turbine assembly may include a vertical turbine shaft mounted perpendicular to a generally horizontal steel brace suspended above water level, with the turbine blades submerged in the flow. The distal end of the vertical turbine shaft may be free (unattached) to the floor of the channel. The brace may span the channel and be anchored to opposing concrete walls thereof. An encased generator may be located in an air space between the water level and a removable cover, for example, in a housing mounted over the brace. Power may be collected from the generators via insulated wiring incorporated into a main power cable for distribution to an energy consumption source. In a preferred arrangement, the turbine, generator, and shaft are oriented along the same vertical axis. The turbine can also include a plurality of hydrofoil blades, which are oriented in a substantially vertical position. Each turbine blade is coupled to a support arm, which is also coupled to the shaft. More than one such assembly may be mounted on each brace.

Another system for power generation at a water reclamation facility comprises an array of turbine and generator assemblies positioned in a sequential arrangement along a conduit or channel used for fast flow water treatment (e.g., aeration or mixing). The sequential arrangement may include arranging the assemblies in an alternating offset pattern along a length of the conduit. Each turbine and generator assembly includes a generator, a turbine coupled to the generator and positioned within a conduit, and a brace supporting the vertical shaft mounted to an upper conduit section. A plurality of electrical connectors may also be coupled to each assembly for transmitting energy output from each assembly to an electrical grid, for example.

This type of power generation system may be located in a water reclamation plant downstream of primary treatment. Primary treatment may include filtration and sedimentation of gross solid materials from the waste stream, followed by biological treatment. Downstream of the primary treatment, an effluent stream may be discharged through a race of relatively long and open narrow channels. Features of the channels, for example relatively narrow channels, introduce increase the velocity of the effluent stream for treatment purposes, e.g., mixing with chlorine or other material.

The effluent channel may have an average minimum liquid sewage depth, which is not less than about 3 feet, for example about eight feet deep. In the transition of sewage flow to water reclamation (recycling), near-final stages (chlorination) of processing produce flow which is fast enough to drive multiple turbines placed in linear sequence. The proposed system consists of a turbine coupled to a generator. In an aspect, the turbine shaft may be mounted perpendicular to a horizontal steel brace, which is fixed to the concrete sides of the rapid flow channel. The turbine blades (paddles) are submerged in the water, whereas an encased generator is oriented in an air space below a removable metal cover. Insulating wires may emanate from each generator may be collected in a wire collection loop, which may form an integral part of one side of a horizontal brace. The wires may merge into a major collection cable directed toward a power consumption source, for example, to provide power to the water reclamation facility itself, or to other systems requiring power input.

Regions of rapid flow in a water reclamation plant may capture flow in a serpentine fashion, and may be are narrower and shallower than antecedent processing tanks. In an aspect, a lower portion of the turbine shaft may be unconstrained, since the assembly is suspended from the horizontal, steel brace. Ten or more channels run parallel to each other in a generally flat plane, the flow being propelled by the gravitational force of incoming sewage, the narrower and shallower channel configuration, and the stepwise downward sloping characteristics of the hydraulic profile of the plant.

Also disclosed herein is a water treatment power generation method, which includes the steps of maintaining an array of turbine and generator assemblies located in a conduit for treated effluent from a wastewater treatment plant; contacting the array with effluent flowing through the conduit; and generating electricity through use of the turbine and generator assemblies. Such methods may also include one or more steps for transitioning sewage flow from a gravity-fed urban sewage system into a wastewater treatment plant. The City and County of Los Angeles are examples of large areas, which utilize gravitational flow so that treatment plants are placed in low lying geographical areas, where less than approximately 5% of sewage movement is pump driven.

Electricity generated by the systems and methods disclosed herein may have several “green” applications. For example, the generated electricity may be used to purify water or to desalinate water to a potable state. In yet another method or system, the generated electricity may be used to manufacture hydrogen fuel from water. Although since the 1920's many patents have disclosed small water turbines, none have considered using wastewater treatment effluent at the near-final, debris-free water reclamation stages for energy generation. In addition, none of these patents are known to disclose specific applications of energy generation for “green” technologies or the use of a treatment plant as an onsite source of power production, as further described herein.

A more complete understanding of the innovative power generation systems and methods disclosed herein will be afforded to those skilled in the art, as well as a realization of additional advantages and objects thereof, by consideration of the following detailed description. Reference will be made to the appended sheets of drawings which will first be described briefly.

### BRIEF DESCRIPTION OF THE DRAWINGS

The drawings described herein are for illustrative purposes and are not intended to limit the scope of the present disclosure. Like element numerals may be used to indicate like elements appearing in one or more of the figures.

FIG. 1 is a perspective view of a sewage or storm water flow system, including a plurality of turbine and generator assemblies in a sewage and/or storm water conduit.

FIG. 2 is a front view of a small turbine for use in the system shown in FIG. 1.

FIG. 3 is a top view of an array for use in a sewage and/or storm water flow system.

FIG. 4 is a top view of an array, coupled to a narrowing component for acceleration of sewage and/or storm water flow rates.

FIG. 5 schematically shows an exemplary power generation and consumption system.

FIG. 6 is a flowchart, showing a method of sewage flow power generation.

FIG. 7 is a lower aerial view of multiple conduits, each containing turbines, that lead into a sewage processing plant, with connections for distributing energy to an onsite structure consuming power for one or more “green” applications.

FIG. 8 is an illustrative diagram showing sequential parts of a typical wastewater treatment plant modified according to innovative aspects of the present disclosure, including a fast-moving effluent flow through a serpentine channel downstream of primary treatment, with installed small turbine arrays.

FIG. 9 is a simplified perspective view showing an array of two turbines for installation in the serpentine channel illustrated in FIG. 8.

FIG. 10 is an front view of an open channel with a vertically-supported small turbine mounted via a bearing pair to one or more generally horizontal braces. Turbine blades are submerged in effluent flow, supported by a shaft that is restrained by a bearing above the surface of the effluent flow and unconstrained at its lower end.

### DETAILED DESCRIPTION

The present disclosure relates to a source of continuous hydrodynamic energy that can have minimal impact on the environment and significantly lower implementation costs for power generation. Large cities virtually can have thousands of miles of rivers flowing under streets and sidewalks, bearing wastewater and watershed runoffs from garden and surface areas. Currently, these rivers add a cost burden to municipalities. The present disclosure explains how these rivers can serve as a source of substantial, continuous, non-polluting hydrodynamic energy, which may be exploited by cities for revenue and cost reduction.

Sewage flow may therefore be an untapped source of continuous hydrodynamic energy. Wind and sunshine may wane, but sewage flow, particularly in urban areas, remains relatively constant. In some major cities, for example, between 700 and 900 million gallons of sewage flows continuously through sewage lines each day. Harnessing hydrodynamic energy from continuous sewage flow, however, may present significant challenges for which the innovative technology described herein provides creative solutions. The following facts illustrate the potential of harnessing energy from sewage flow in just one metropolitan area:
The County of Los Angeles County currently operates eleven sewage water reclamation plants.
The City of Los Angeles' Department of Sanitation currently operates four sewage water reclamation plants in collaboration with the Department of Water & Power. These plants are named Tillman, Hyperion, Glendale, and Terminal Island.
In 2006, Tillman, Hyperion, Glendale, and Terminal Island each respectively yielded approximate sewage flow rates of 40, 323, 17, and 16 million gallons/day.
Daily power usage for a large city (e.g. Los Angeles) is about 5000 megawatts.
Estimated combined sewage flows in the City of Los Angeles and the County of Los Angeles is approximately 800 million gallons/day. A sewage flow power generation system could generate a significant amount of energy, depending upon the number of turbine arrays installed.
In the City and County of Los Angeles, over 95% of sewage flow is gravitational, and not propelled by pumps because the water reclamation plants are placed at lower elevations than surrounding residences and buildings. Furthermore, within the plant itself, water flows downward, dropping 3-4 feet from each treatment tank to the next, and may reach velocities usable for power generation in certain post-treatment channels.
Main collection line sections of sewage lines in Los Angeles City and County have diameters ranging from 81 to 96 inches, which would allow a person to fit within a main line for servicing. Major interceptor lines may be large, for example, such lines at Hyperion may be up to 10 feet in diameter.
In order to process water to a non-potable state required for discharge, Tillman's expenses are approximately $45 million/year. Processing at Tillman requires a continuous supply of about 4 megawatts of electrical power every day, for necessary lighting and equipment. Based on this value, estimated combined costs for other plants in may be on the order of $1 billion/year in Los Angeles City and County.

Gravity-fed sewage systems such as in Los Angeles City and County currently waste hydrodynamic energy that that accompanies sewage flow or processing. Hydrodynamic energy generated by turbine and generator assemblies is effectively renewable energy, which may be used to generate electricity for various types of “green” technologies. For example, generated electricity from the assemblies may be used for power consumption and include methods of water purification, water desalination, and production of hydrogen fuel. These “green” technologies, while greatly desirable, if previously proposed methods are used, have the potential to pull undesirable amounts of electricity from a community grid. As such, the flow systems described herein can be utilized in a power plant, which would self-support system maintenance and repair and provide revenue for communities in surrounding areas.

Earth is about seventy-two percent (72%) water. But, only about two-percent (2%) of water on Earth is suitable for human consumption. And, most of this two-percent is primarily used for non-drinking purposes. Purification and desalination are just two of the viable uses for energy generated from the systems described herein.

Purification of sewage and storm water flow requires power which in many cases is derived from an already-stressed community grid. The energy intensity for reclamation and re-use of non-potable water can be 1.84 kilowatt-hours per kilo-gallon (kWh/kgal) at a cost of $0.46/kgal for at least one major city in the United States as of 2011. Desalination of sewage and storm water flow is also a process which demands significant power. For desalination, energy cost is 12 kWh/kgal or $3.10/kgal in at least one major city in the United States as of 2011. (See, “Water Re-Use Potential,” National Research Council, National Academy Press, 2011).

Many cities include up to six watersheds that empty into the ocean, providing water which could be used for desalination. Therefore, utilizing the electrical energy from this type of water flow could provide the additional energy necessary for providing potable water or hydrogen fuel without extracting energy from existing electrical grids. Line loss could also be prevented by providing onsite production of electrical energy, especially for desalination at ocean discharge sites.

Electrical energy generated from the systems and assemblies described herein may also be utilized to manufacture hydrogen fuel from water. High costs associated with manufacture of hydrogen fuel are typically cost prohibitive. At least one source indicates that producing hydrogen fuel from water or other compounds consumes more energy compared to the energy recovered when the hydrogen fuel is burned. In addition, approximately 3.58 gallons of liquid hydrogen fuel provide the same energy contained in approximately one gallon of gasoline. As of 2012, hydrogen fuel derived from water may cost up to $8.00 (US$) per gallon, or almost $30 (US$) to yield the same miles per gallon (mpg) as gasoline. Even if hydrogen fuels were derived from steam-injected methane hydrogen, costs to produce the hydrogen fuel may only be slightly less and still require electrical energy. According to one scenario, electricity produced at a selected wastewater processing plants could potentially lower the cost of hydrogen fuel production. This could revitalize use of hydrogen fuel. High costs typically associated with manufacture of hydrogen fuel could be offset by using the sewage and/or storm water flow systems and turbine and generator assemblies, and arrays described herein. Eventual development of a prototype may provide proof of concept for evolving these “green” systems from uneconomical technologies to useful and important assets.

Prior projects which propose to harness energy from wastewater flow have not considered a prime necessity—the need to avoid too much interference with flow momentum and/or reduction in hydraulic head needed to facilitate efficient processing of residual water from raw sewage to a non-potable but purer state. For example, several prior disclosures propose box-like enclosed channels through which sewage must be diverted along flow channels not in line with the hydraulic profile of a downstream treatment plant. For further example, another discloses mounting turbine assemblies into pipes, requiring extensive reconstruction of existing structures. These prior approaches may include mounting turbine assemblies to the conduit floor, making access for maintenance and repairs more difficult and costly. In contrast, the present disclosure teaches placing turbine assemblies into a current hydraulic profile of a wastewater treatment plant without requiring structural changes to flow channels. These turbine assemblies are placed to not interfere with flow direction or cause undesirable reduction of hydraulic head, and placed downstream of primary treatment processes at a location where there is little or no debris. The turbine assemblies are not constrained by any mounting under the surface of the effluent flow, and are free of any contact or connection to submerged portions of the flow channel. Instead, the turbine assemblies are suspended over the flow channels. Besides facilitating more efficient maintenance and repairs, and minimizing component subject to corrosion from being submerged in the aqueous effluent, this suspended configuration ensures minimal interference with flow dynamics by avoiding any unnecessary submerged components, such as turbine shafts. These special features are described in more detail below, for example under the heading “Post-Treatment Power Generation.”

In this proposal, problems with capturing hydropower from sewage flow are overcome by locating one or more small turbines (e.g., a turbine array) in the wastewater treatment plant, downstream of primary treatment ponds or processes after most of the solid waste and debris have been removed. A treatment section may include a turbulent flow raceway for aeration and/or mixing of treatment chemicals. For example, a raceway may comprise a rectangular or U-shaped open channel arranged in a serpentine pattern. The serpentine pattern may enable a long raceway to be contained in a relatively compact area as the flow is directed through sharp turns, while causing a substantial increase in the effluent flow velocity. Such channels are shallower and narrower than prior treatment tanks. Small turbine arrays may be mounted in these fast-moving open channels of treated effluent, to recover excess hydropower that would otherwise be discarded at the effluent outlet.

In one mounting arrangement, a brace or support is fixed to one or both sides of the open channel, above the water level. A vertical-blade turbine, e.g., a Davis-type turbine or Gorlov-type turbine, may be mounted to the brace via a vertical shaft passing through a pair of bearings fixed to the brace above the upper surface of the effluent flow. The shaft may be free (unconstrained) in its submerged portion. The vertical mount may enable the turbine and generator to be lifted easily out of the effluent flow for maintenance or repair.

A generator may be mounted to the top of the vertical shaft and generated electricity drawn off for power regulation and use by the wastewater treatment plant. To the extent excess power is generated, it may be supplied to the grid or to any other suitable power sink.

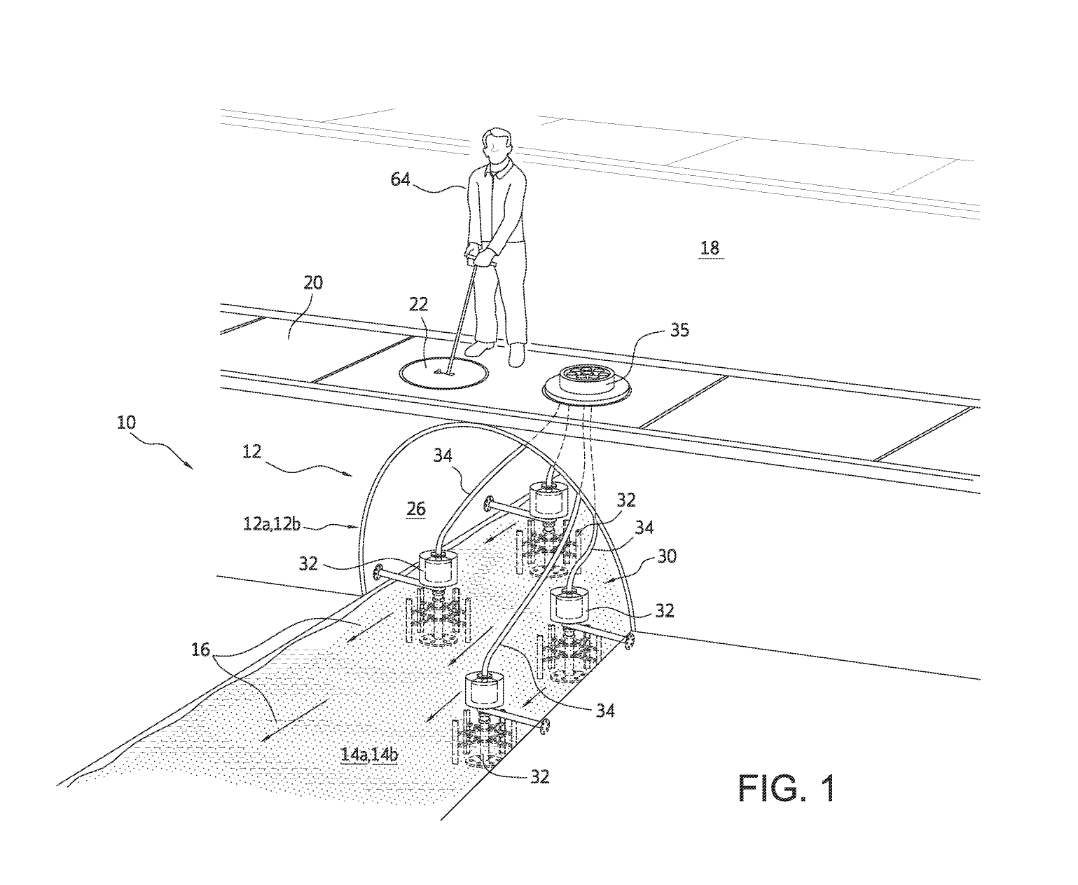

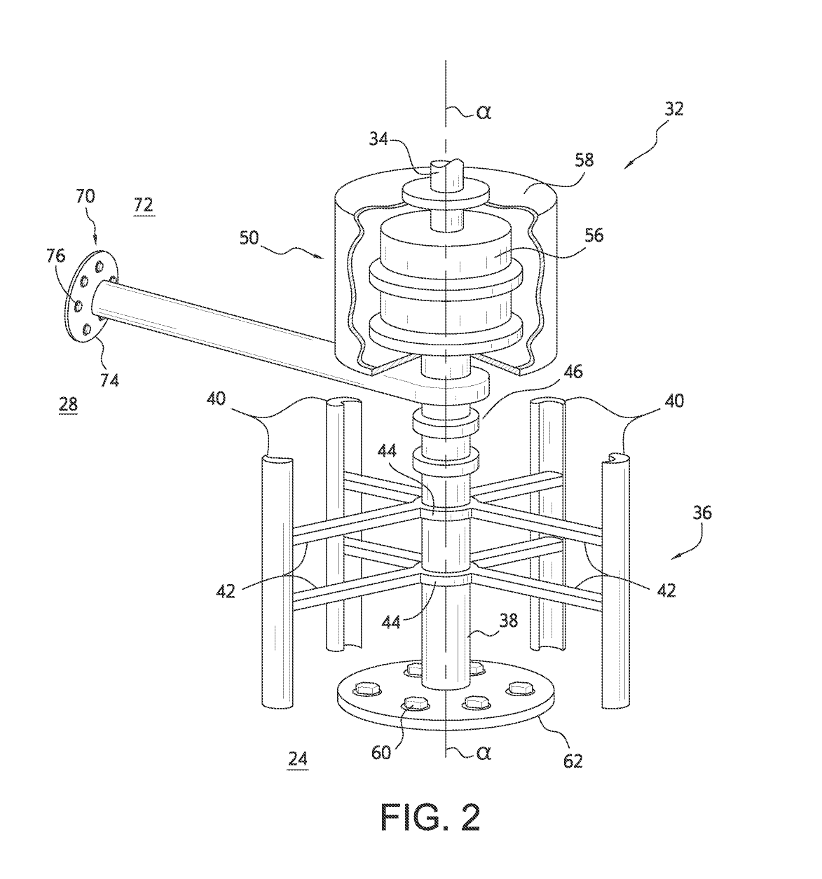

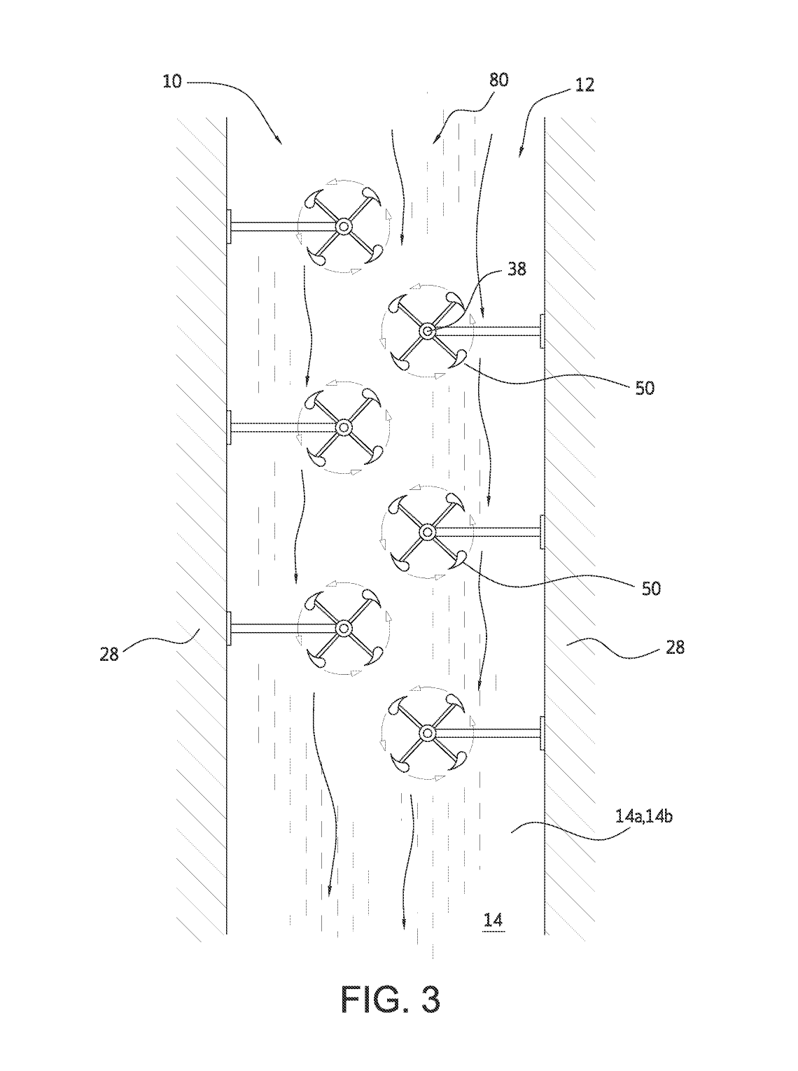

Turning in detail to the drawings, FIG. 1 shows a sewage and/or storm water flow system 10 positioned within a conduit 12, such as a sewage conduit 12a or storm water conduit 12b, containing sewage flow 14a and/or storm water flow 14b. As used herein, sewage flow is generally defined as water, containing particulates that originate from waste water drainage systems positioned at least partially underground. Similarly, storm water flow, as used herein, is generally defined as water, which originates from storm water drainage systems positioned at least partially underground. Storm water flow 14b can therefore include, but is not limited to flow emanating from lawns, gutters, and drainage systems for industrial facilities. Arrows 16 generally indicate the direction of the flow 14a, 14b in the conduit 12. Conduits of this type may be typically positioned underground, i.e. underneath streets 18 and sidewalks 20 in urban areas, which include points of access 22 to conduits 12. Access for servicing may also be gained through an open end of the conduit 12, after flow has been temporarily blocked or shunted away. These types of conduits can include a lower conduit section 24, e.g. a bottom or conduit base (FIG. 2) positioned under sewage or storm water flow, an upper conduit section 26 (FIG. 1) positioned above sewage or storm water flow, and sidewalls 28 (FIG. 3).

The system 10 may include a plurality 30 of turbine and generator assembles 32, with each assembly being coupled to one or more electrical connectors 34, which integrate into a collection of cables contained in a housing 35. These connectors may include cables or wiring used to link with an electrical grid, which can provide power to local and distant recipients, for example. The housing 35 may be positioned above ground for coupling with the electrical grid. To avoid line loss, however, onsite energy conveyance is one aspect of a preferred system embodiment.

Referring to FIG. 2, each turbine and generator assembly 32 includes a turbine 36, having a shaft 38, which acts as a rotor, and turbine blades 40. The turbine blades 40 are coupled to the shaft 38 via support arms 42, using shaft couplers 44. One or more support arms 42, which are coupled to shaft couplers 44, are connected to turbine blades 40, as shown in FIGS. 1 and 2. The shaft couplers 44 act as a hub for rotation of the blades around shaft 38. One or more bearings 46 may also be coupled to the shaft 38.

Hydrodynamically shaped hydrofoils may be used as turbine blades 40. Hydrofoil blades are less likely to trap particles flowing through sewage flow. In one configuration a plurality of turbine blades 40 are oriented to a substantially vertical axis α and positioned in a symmetrical arrangement with respect to the vertical axis α to spin 360 degrees around the shaft 38.

In one blade arrangement, four turbine blades are positioned in about 90 degree increments with respect to the vertical axis, as shown in FIG. 3. Blade arrangements may include four to six blades positioned symmetrically with respect to axis a. However, various blade arrangements may be suitable, depending on the size and shape of turbine blades. Blade types and arrangements shown herein are not to be construed as limiting. Alternative blade arrangements include those used in Davis-type turbines, Gorlov-type turbines, modified Davis-type and Gorlov-type turbines, and other types of turbines designed for underwater applications in lower flow systems.

Referring again to FIG. 2, the turbine 36 and its respective components are used to convert power from sewage and/or storm water flow 14 into mechanical power via the shaft 38. The turbine may be configured to have an overall height ranging from about three feet to about five feet, depending upon conduit depth and anticipated flow heights. Therefore, the turbines specified herein are small, meaning each turbine has an overall height of less than about four feet. The height of the turbine, however, should be high enough for complete or at least partial submersion of turbine blades when flow is initiated within a conduit.

All turbine components are preferably manufactured from one or more materials, which are substantially resistant to chemicals likely present in sewage flow 14a and/or storm water flow 14b. In each turbine and generator assembly 32, torque from the shaft 38 is transmitted to a generator 50 or another type of power transfer device. In one configuration, the generator may include one or more electrical components 54 (not shown) and a gearbox 56 for converting rotation from the shaft to a higher rotation suitable for generating electricity. Various types of gearboxes may be included within the assembly 32.

The generator 50 may be encased within a housing 58, which is substantially impervious to water, sewage, weather and environmental moisture. FIG. 2 shows a break away view of generator components encased within the housing 58. The housing may be manufactured from one or more materials, which are substantially resistant to corrosion and degradation, resulting from frequent contact with sewage and/or storm water flow. Coupled to the gearbox 56 are one or more electrical connectors 34, which are used to transmit energy from the generator 50 to an electrical grid configured to provide power to local and distant recipients.

In one arrangement of a turbine and generator assembly 32, the shaft 38 is coupled to the lower conduit section 24, using bolts 60 or alternative fastener types, which are coupled to an assembly base 62. In an alternative arrangement of a turbine and generator assembly (not shown), the shaft 38 may extend through to a generator positioned above a street 18 and/or sidewalk 20 (FIG. 1) above the conduit 12. This type of arrangement may also prevent complete or partial submersion of the generator, particularly during levels of high sewage and/or storm water flow.

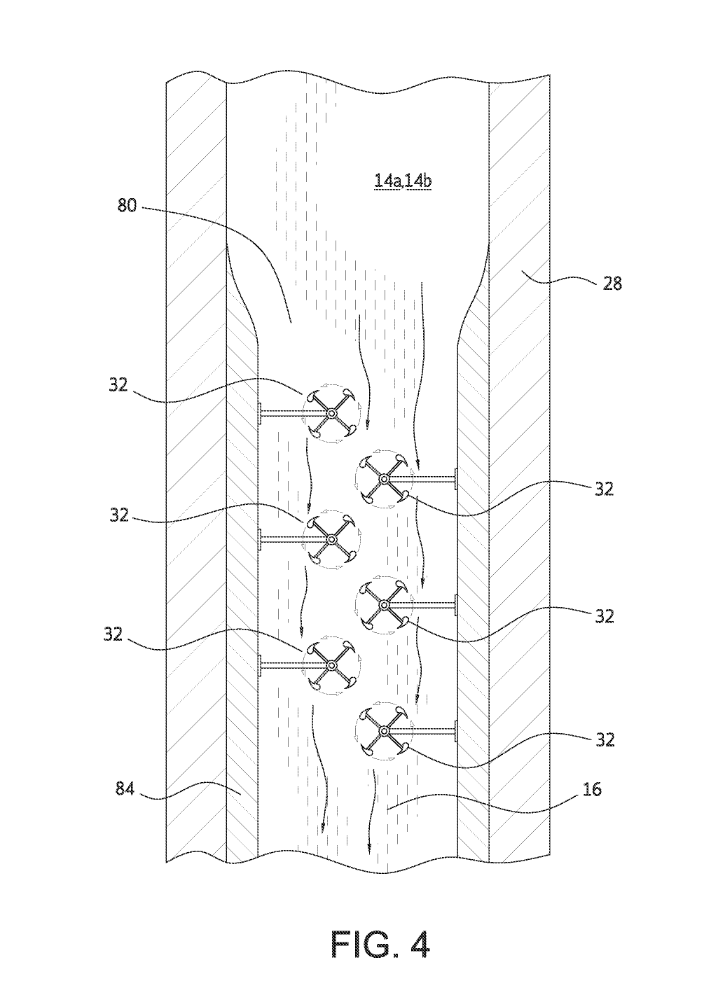

Turbine and generator assemblies 32 may also include at least one anchor 70 coupled to the shaft 38 and to at least one wall section 72 of the conduit 12. For example, an anchor 70 may be coupled to a conduit sidewall 28, as shown in FIG. 2. This type of arrangement may avoid interference with shaft rotation via an aperture in the end of the anchor distal from the wall section 72. The aperture in the anchor may be dimensioned with sufficient clearance for the shaft to freely rotate. The anchor 70 allows an assembly 32 to resist movement when subject to sewage and/or storm water flow. The anchor may include an anchor base 74 that is coupled to the wall section 72 or a narrowing component 84 (FIG. 4), using fasteners 76 such as bolts or screws. One or more bearings (not shown) may also be coupled to the anchor. All anchor components are preferably manufactured from one or more materials, which are substantially resistant to chemicals present in sewage flow and/or storm water flow. The materials may include, stainless steel, e.g. 316 stainless steel.

Flows in a sewage and/or storm water system 10 typically flow at lower flow rates. Incoming flows, for example, can range from about 5 feet per second to about 15 feet per second. As such, a turbine and generator assembly may be positioned at one or more inflow passages, i.e. a passage typically within about 50 to about 100 feet of a water treatment facility. Sewage and storm water flow rates at inflow passages are likely to be greater compared to outflow passages. Nonetheless, the system 10 may also be placed close to outflow passages, where outflow rates are sufficient. Narrowing components 84 (FIG. 4) may be required to accelerate flow in inflow and outflow passages. Sewage and storm water flow at inflow passages are also known to have a greater percentage of liquid (typically over 90%), which further lessens the chance of solid particles being captured by turbine blades 40.

In addition, the system 10 is preferably located in a conduit, having an average minimum liquid sewage depth not less than about 3 feet. Alternatively or in addition, an array 80 may be arranged in a sewage conduit of a sewage system located at one or both of within about 1000 feet downstream of a sewage treatment facility or within 1000 upstream of the sewage treatment facility.

Turbine and generator assemblies 32 may be uncoupled to computer systems, flapper gates, or valves required for flow regulation. Each turbine used in an assembly is configured such that its rate of rotation may vary, depending on incident variations of sewage and/or storm water flow in the system. In some assembly arrangements, however, flow meters may be utilized to monitor energy produced by the assembly 32 or the plurality 30 of turbine and generator assemblies.

In a preferred arrangement, a turbine and generator assembly may also be positioned close to one or more points of access 22 so that one or more maintenance workers 64 (FIG. 1) may maintain, repair, and/or replace the assembly when and if necessary.

The plurality 30 of turbine and generator assemblies 32 may be maintained in an array 80 such as a sequential array within the conduit 12, as shown in FIG. 3. The array shown in FIG. 3 is an offset or “zig-zag” array, which can provide adequate space for maintenance, repair, and replacement of assembly components. For example, during maintenance periods repair personnel may perform periodic, routine cleaning and servicing. The array is preferably positioned within the conduit such that personnel may access the array via the point of access 22 located on a street or sidewalk, for example.

When and if necessary, conduits may be modified to narrow conduit width, thereby increasing velocity of sewage and/or storm water flow. Wider sewage conduits may be modified to add a structural material, (e.g. concrete), to wall areas 82 adjacent an array 80. In addition, as shown in FIG. 4, a narrowing component 84 may be included within a conduit to narrow a conduit section 86, containing the sequential array 80. Without these types of modifications, difficulties may be encountered which limit conduit velocity to below operating ranges for many types of hydraulic turbines. Typically flow rates less than about 10 feet/second can cause slow rotation for some types of turbines. Therefore, to increase flow velocity, the conduit width or pipeline diameter may be constricted, especially for gravitational flows. Installation of a narrowing component 84, such as that shown in FIG. 4, may require minimal alteration to existing conduits. Narrowing components could, for example, be located adjacent a sequential array 80 such that flow rates where turbines are located are increased to sufficient levels.

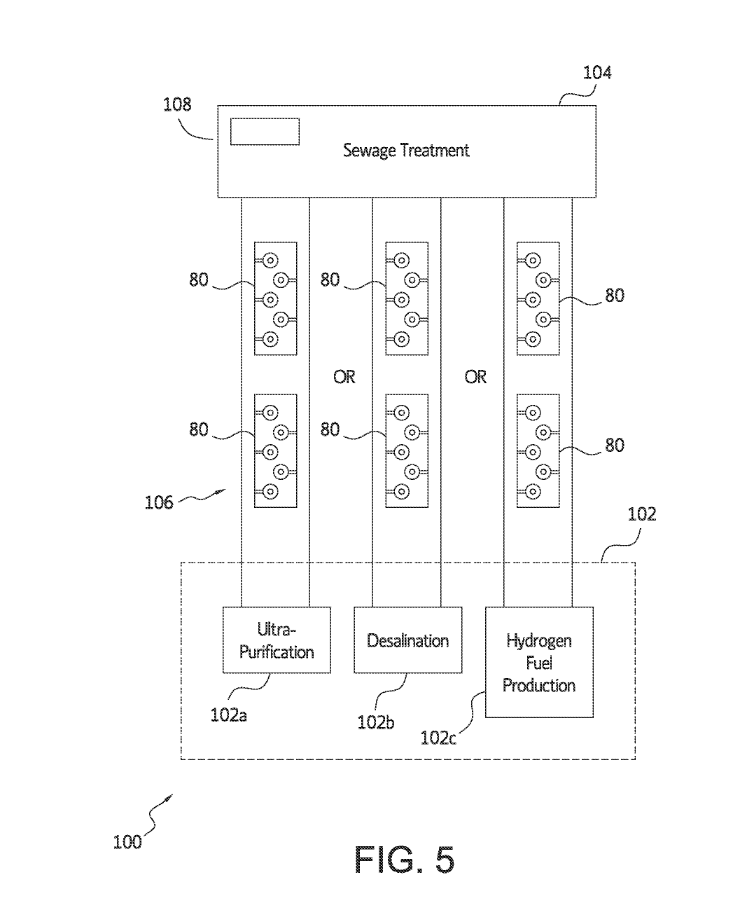

FIG. 5 schematically shows one exemplary power generation and consumption system 100, including one or more power consumption systems 102 (also called “synthesis plants”) that implement various types of “green” technologies, utilizing energy harnessed from the systems and assemblies described herein. For example, a power consumption system 102 may be a treatment plant for purification 102a and/or desalination 102b of water or a production facility 102c for hydrogen fuel. A treatment plant for desalination may, for example, be situated where treated sewage or storm water empties into saltwater bodies (e.g. coastal areas). The system 100 can further include the sewage treatment plant 104, which is the source of sewage and/or storm water flow, a plurality of sewer lines or conduits 106, and one or more arrays 80. Included within the treatment plant 104 may be one or more waste water processing centers 108, which may be used, in part, to consume electricity generated to process the sewage within the system 100 itself, replacing power that would otherwise be drawn from other sources powering the general community grid.

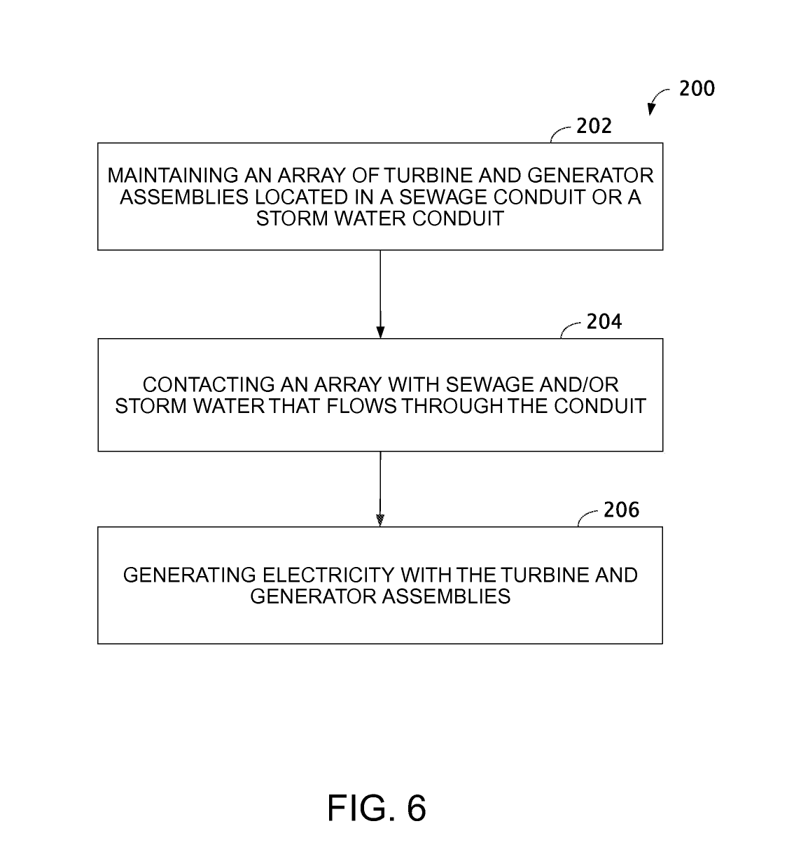

As shown in FIG. 6, a method for sewage flow power generation may include various steps for deriving energy from one or more turbines, turbine and generator assemblies, or at least one array of turbine and generator assemblies, installed in a treated effluent stream of a gravity-fed wastewater treatment plant. One method of power generation 200 may include, at 202, maintaining an array of turbine and generator assemblies located in a a rapid-flow effluent conduit downstream of one or more primary treatment processes. By maintaining the array, the method may also include at 204, contacting an array with effluent that flows through the conduit, and at 206, generating electricity with the turbine and generator assemblies. After electricity is generated, the wastewater treatment plant may consume all, or a portion of, the generated electricity. Additional method steps may include directing the sewage flow from a gravity-fed urban sewage system into the conduit or directing the sewage flow from a gravity-fed storm water discharge system into the sewage conduit. These methods may further include additional steps of, using the generated electricity to purify or ultrapurify water, desalinate water, and/or manufacture hydrogen fuel at the synthesis plant.

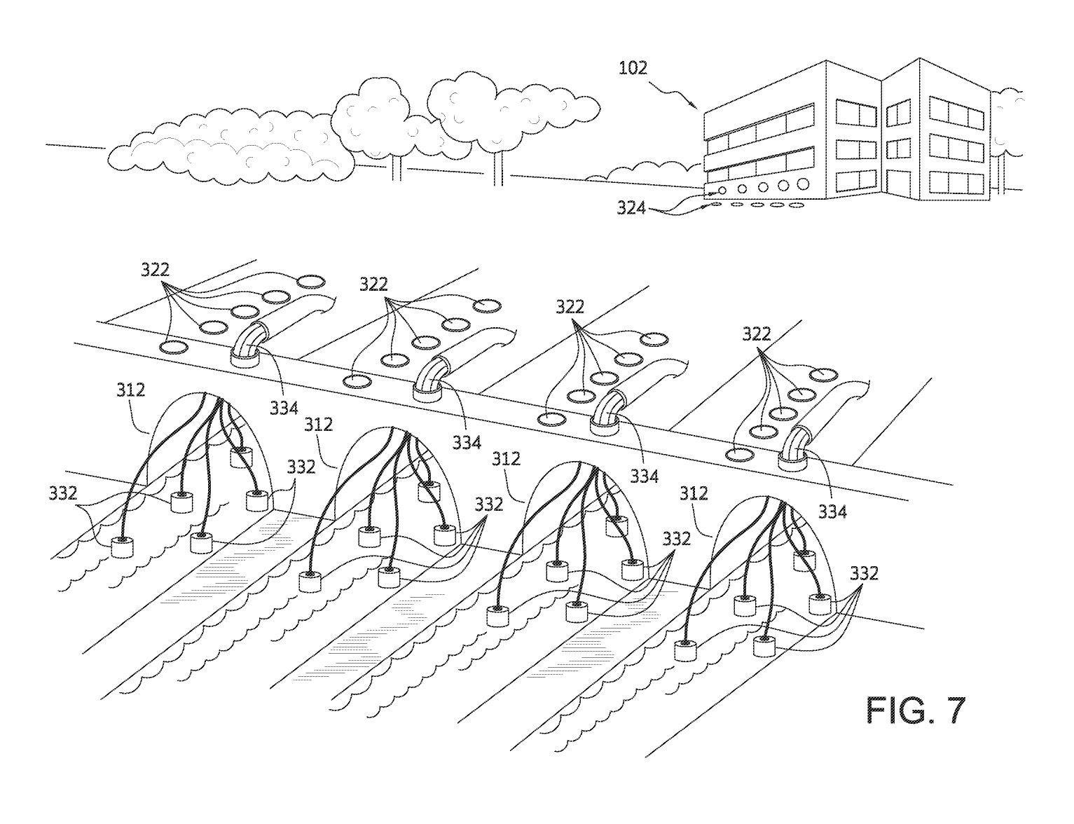

FIG. 7 shows a low aerial view of a system having multiple conduits 312 configured to enter into a power consumption system 102 such as, for example, a synthesis plant. Each conduit may contain an array of turbine/generator assemblies 332, which are coupled to electrical cables 334 for transmitting power to a power grid or other power consumption unit 102. The power consumption unit 102 may also include multiple ports 324 for entry and exit of the electrical cables 334. Multiple points of access 322 to the system may also be provided. When this type of system is in use, electrical power generated may be proportional to the number of conduits 312 and the number of turbine/generator assemblies within in each conduit 312, compounding the energy produced.

### Post-Treatment Power Generation

Portions of the disclosure above describe the utility of installing an array of turbine-generator assemblies within 1000 feet of entry into, or exits from, a sewage processing plant, not excluding the area within the processing plant itself. In a separate aspect of the disclosure, focus is on utilization of specific hydroflow characteristics within the water recycling plant that intervenes between the sewage entry and the exit flow, within a wastewater treatment plant. Such a treatment plant may operate to return treated water (effluent) in a non-potable state to community lakes, watering facilities, and, ultimately, to the ocean. The water recycling phase can also serve as a power production plant, or even preferably so.

In applying this dual role for flow, an innovation cannot interfere with the primary process, i.e. the steps necessary to assure the separation of human waste from the water which has carried it into the plant, and to transform this water into a much purer but still non-potable state. Complex compartments, set up to transform hydroflow into energy, as demonstrated in much of prior art, would subject the system to obstruction, interfering with linear flow patterns.

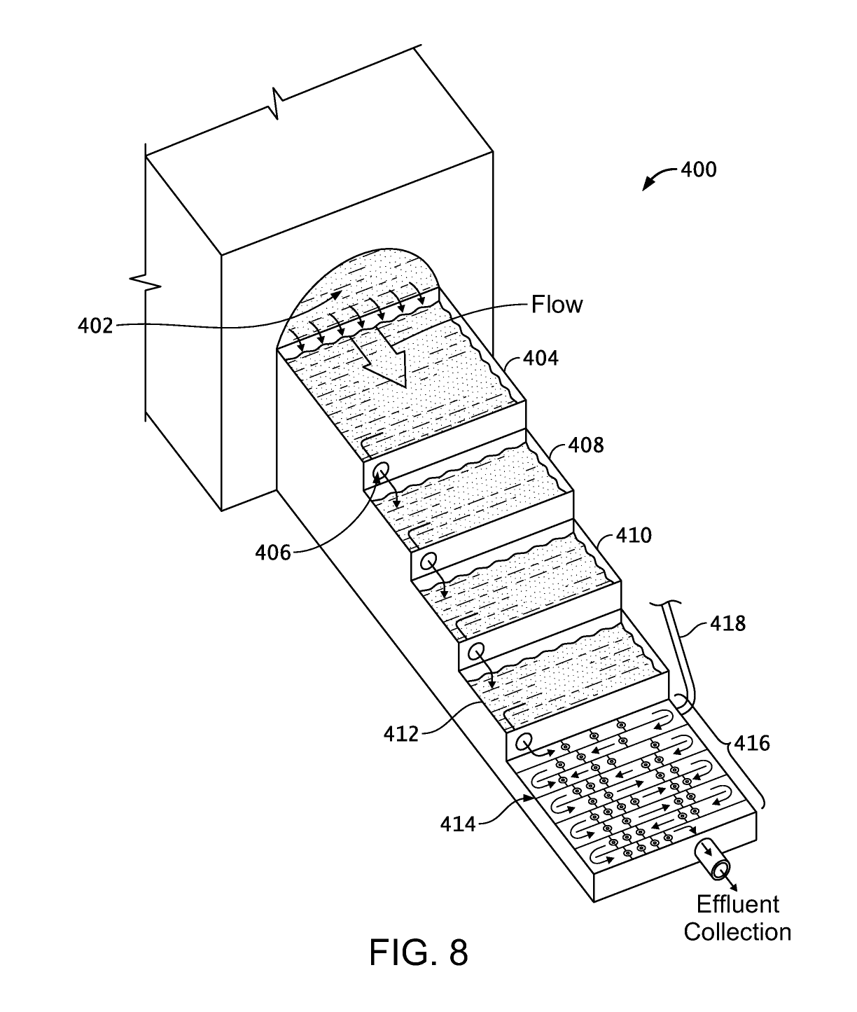

The flow patterns within the plant differ greatly from that at its entries and exits. For example, FIG. 8 shows a schematic hydraulic profile of a water reclamation facility 400 (not to scale), also called herein a water treatment plant, facility or process, including a turbine array 416 for recovery of hydropower. The illustrated hydraulic profile is based on an actual hydraulic profile of a treatment plant (Tillman facility) in the City of Los Angeles. Estimated approximate dimensions of a typical treatment plant are about 300 feet wide and 1200 feet long.

1) Inflow at the inlet 402 from the community may be gravitational. Additionally, within the plant, flow is enhanced further, via a downward, stepwise design with a series of three to four foot drops between each tank, discharging to a relatively fast-flowing raceway configured as open channels. For example, a first tank 404 may be configured as a screw pump tank for settling and sludge or sediment removal. An outlet 406 of the first tank 406 may discharge into a second tank 408 via control valves (not shown) controlling the rate of flow. The second tank 408 may be configured for primary treatment by bacterial action, and may similarly discharge into a third tank 410 configured for aeration and further removal of nitrogen and organic waste. The third tank 408 may discharge to one or more additional tanks 412 for final sedimentation and filtration. Each tank in the series of tanks 406, 408, 410 and 412 may be about three to four feet lower than the outlet of the previous tank or sewage inlet, to enhance gravitational flow.

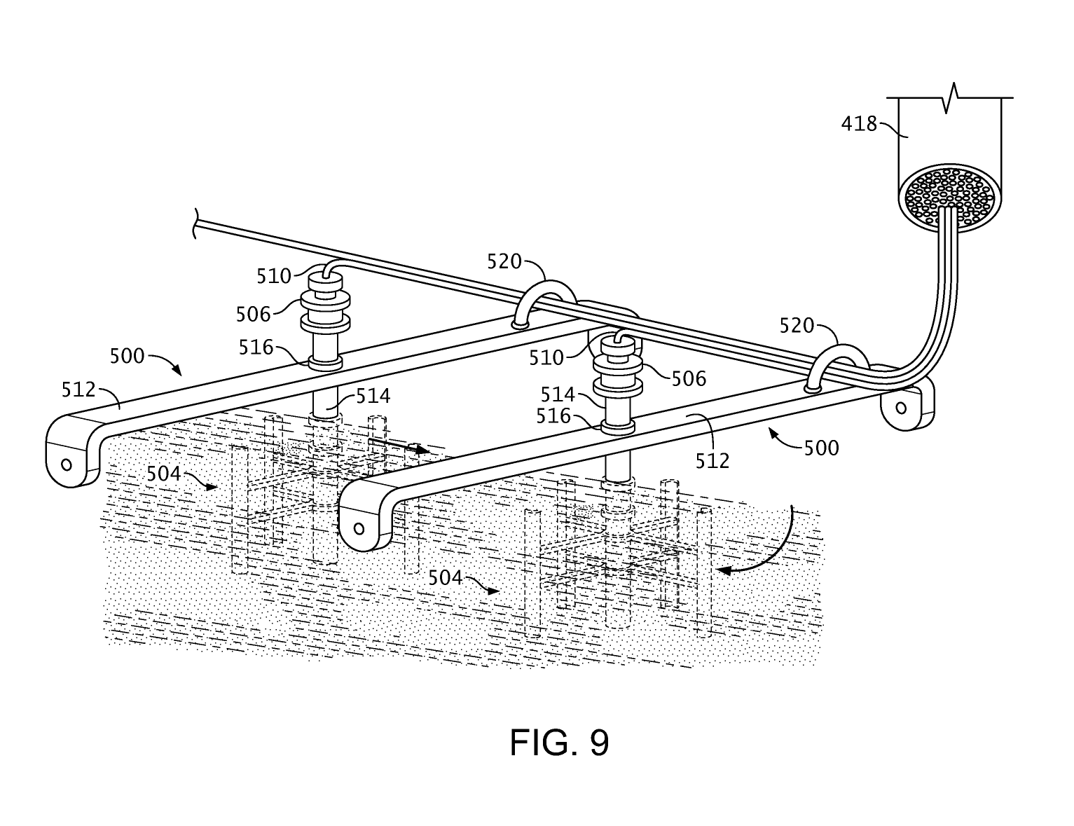

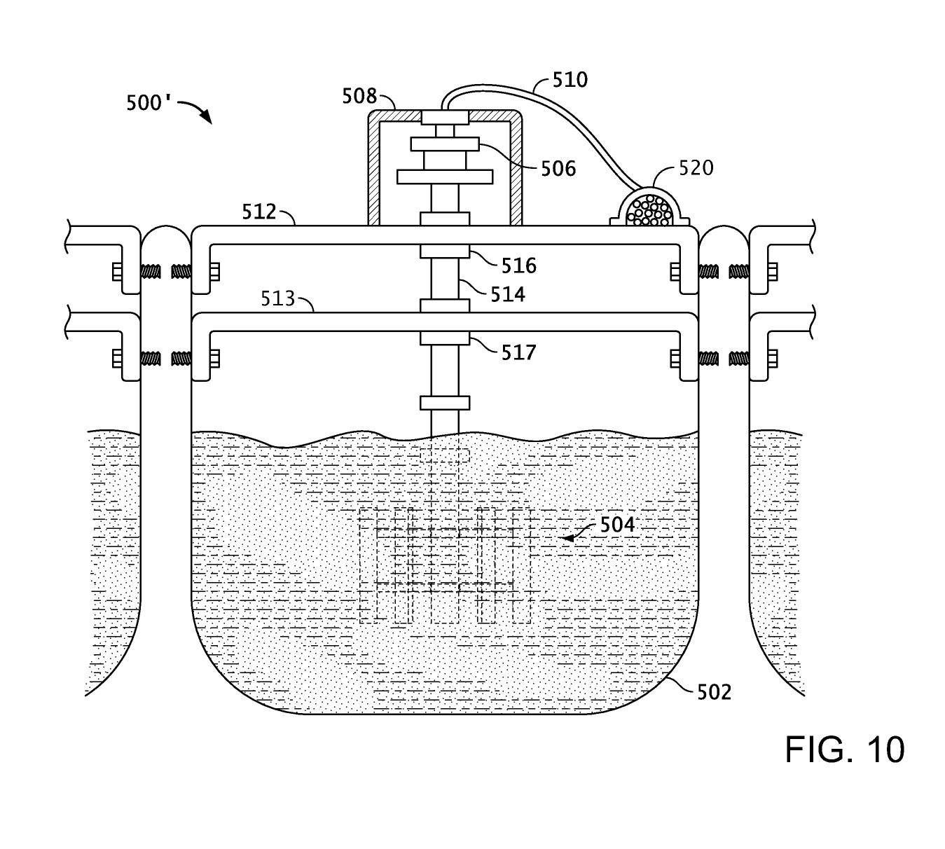

2) In a near-final stage (chlorination), the channels are greatly narrowed, and reduced in depth. Downstream of the final tank 412, effluent is discharged to serpentine flow channels 414 through which the rate of flow is relatively rapid, for example, in the range of about four to six times faster than in upstream treatment tanks, or faster. In one plant (Tillman), an effluent stream of about 40 million gallons per day passes through the channels 414, which are about ten feet wide, of generally rectangular cross-section, open to the air, with a surface in an air space below a removable metal cover. and filled with effluent to a depth of about eight feet. Because of the antecedent treatment, there is much less debris in the flow at the chlorination stage. The serpentine flow channels 414 are suitable location for installation of a small turbine array 416. Power from the array 416 may be collected via a main collection cable 418, comprised of insulated conducting wire from each turbine. Individual turbines in the array may be as described in connection with FIGS. 9-10 below.

3) Similar water reclamation plants may be found elsewhere in Los Angeles, and in other cities with gravity-fed sewage systems, making it feasible to utilize hydropower as an environmentally clean resource. Current hydropower utilizes flow from lakes, waterfalls, and reservoirs, presenting some environmental concerns. Utilization of water reclamation facilities for energy production can convert them into money earners, not money burners, without adverse environmental impact.

In order to be practical, and translatable to community usage, a system of turbines in a series of water reclamation canals must not interfere with the principal purpose, i.e., recycling of water. Though as it enters the plant, the sewage is over 95% water, debris in the flow can obstruct passage. Prior art gives little or no consideration to this problem.

For example, some have proposed locating turbines into sewage pipes, rather than in major conduits entering the plant. The pipes range in diameter from two to four feet, making them easy prey for obstruction by solid material in the sewage. Furthermore, in most large cities, pipes are ceramic, aged, and subject to breakage. Repair or replacement with attached turbines would be prohibitive, financially. Others have given little or no consideration to the location of the turbines, have not anticipated obstruction to flow, and have failed to identify any particular stage of sewage processing as suitable for turbine installation. No prior art specifies that the power generated would be less dissipated by line loss if used at the processing site.

In view of the long felt need and failure to come up with practical solutions for harnessing hydrodynamic power from sewage flows, effective solutions to the problem of extracting energy from sewage flows are not obvious. Innovative, multi-disciplinary perspectives are needed, that encompass areas such as sanitation engineering, hydrodynamics, electrical engineering, and mechanical engineering, without being limited to conventional solutions in these disciplines. Past proposals have failed to adequately synthesize the teachings of disparate disciplines and over come the deficiencies of the prior art. The novel and inventive methods for capturing energy from sewage flows as presented herein incorporate combinations of features lacking in prior proposals.

For example, prior proposals fail to consider and make use of detailed hydraulic profiles characteristic to many gravity-fed urban wastewater treatment plants, which are dedicated to environmentally friendly water recovery from wastewater. The quality of water flow, sediment, flow rate and other factors have not been adequately considered in relation to turbine configuration or placement. In addition, although turbines have long been used for hydropower, prior turbine mounting configurations are not optimal for recovery of energy from wastewater. The present disclosure therefore describes innovative mounting configurations in which a turbine is suspended in the fluid flow from an upper bearing located above the water surface, thereby reducing drag on flow in the channel that would otherwise result from supports in the sides or bottom of the channel and enhancing ease of maintenance operations.

Aspects of the disclosure are directed to the concept that certain channels within a water recycling facility can produce electricity when turbine/generator systems are placed within them, in order to interact with the rapid, liquid flow which characterizes a later stage of the process. Intrinsic to the reclamation of water, at an important stage, flow increases in velocity, in serpentine fashion, and can provide motile force to perform this job. The embodiment for the assembly is unique, in that it is secured and suspended from above, by steel braces. Multiple turbine assemblies (not shown) may be mounted to each brace to increase power density of a turbine/generator array, where feasible.

In an aspect, one or more turbine assemblies of an array are mounted from above, using a brace or equivalent mounting structure. With reference to FIGS. 9 and 10, each turbine assembly 500, 500′ is not anchored to the bottom of the channel 502, being supported instead near the upper end of the turbine by the steel brace 512 attached to the channel walls. The turbine 504 is submerged, while the encased generator 506 is above flow, in the air space, below a protective, removable metal cover 508 (cover is also part of current structure). Insulated wires 510 are collected and organized by passage through a wire collection loop 520 placed at the end of each brace, and extend from each generator to a curved portion at the end of the serpentine channel and meet with other such cables from each generator, to combine with a main collection cable 418 which travels to an onsite power consumption source to provide electricity to run the plant, or for other, on site processes.

A generally horizontal brace 512 of zinc-plated steel or other material may span the channel 502, supporting a generally vertical main shaft 514 of the turbine 504 via a bearing 516. The shaft 514 of the assembly may be suspended at an upper portion thereof, and extend from below the brace 512 in a lower portion free of any connection to, or contact with, the channel 502. In the alternative, referring to FIG. 10, for enhanced stability of the assembly, multiple braces 512, 513 may be used, supporting the shaft 514 via respective multiple bearings 516, 517. The braces 516, 517 are not limited to the depicted configurations. For example, the brace may be cantilevered off of one side of the channel, and/or may support multiple bearings in a unitary structure. The bearings 516 may comprise any suitable bearing for use near water and capable of supporting a side load, for example a sintered sleeve bearing including durable and lubricating metals. The bearing may be sealed and supplied with lubrication via a lubrication system (not shown) installed over the brace 512 or 513. It should be appreciated that the bearing 516 may comprise a sleeve bearing, a split bearing, a collar encasing a ball bearing or roller bearing, or any other suitable mechanical bearing for constraining a rotating shaft against a lateral force.

Accordingly, sewage and wastewater treatment effluent flow power generation systems and methods, using generator and small turbine assemblies and arrays are disclosed. Embodiments of this invention have been shown and described as examples, and modifications are possible without departing from the inventive concepts herein. The invention, therefore, is not to be restricted except in the spirit of the following claims.

What is claimed is:

1. A power generation system, comprising:
a sequential array of turbine and generator assemblies positioned within an effluent flow of a wastewater treatment process downstream of a primary treatment process each providing output power to a main collection cable, wherein each assembly comprises:
a generator located above a water level of the effluent flow,
a turbine located in the effluent flow and configured for turning around a substantially vertical shaft coupled to and below the generator;
and
at least one bearing enclosing a portion of the shaft, mounted to an upper portion of a channel containing the effluent flow above the water level, wherein an end of the substantially vertical shaft distal from the generator is unconstrained, whereby the substantially vertical shaft is cantilevered from the at least one bearing.

2. The system of claim 1, wherein the turbine and the generator are oriented to the substantially vertical axis of the shaft.

3. The system of claim 1, wherein the turbine comprises a plurality of blades oriented to a substantially vertical axis, the plurality of blades at least partially submerged in the effluent flow.

4. The system of claim 3, wherein each of the plurality of blades is coupled to the substantially vertical shaft via a support arm.

5. The system of claim 2, wherein the at least one bearing is mounted to an upper portion of a channel via a brace.

6. The system of claim 5, wherein the brace is substantially horizontal.

7. The system of claim 5, wherein the brace is fixed to opposing sides of the channel.

8. The system of claim 5, wherein the shaft of the assembly is suspended at an upper portion thereof, and extends from below the brace in a lower portion free of any connection to, or contact with, the channel.

9. The system of claim 1, wherein the generator is contained within a housing that is substantially impervious to the effluent.

10. The system of claim 1, wherein the shaft and the anchor each comprise stainless steel.

11. The system of claim 1, wherein the sequential array comprises the turbine and generator assemblies arranged along a length of the channel.

12. The system of claim 1, wherein the sequential array is located in an effluent channel having a serpentine configuration.

13. The system of claim 1, further comprising a wire collection harness connected to a power output port of the generator and comprising power transmission wires connected to a junction for the main collection cable.

14. A power generation method, comprising:
maintaining an array of turbine and generator assemblies located in an effluent flow of a wastewater treatment process downstream of a primary treatment process and each providing output power to a main collection cable;
contacting the array with the effluent flow flowing through an effluent channel; and
generating electricity with the turbine and generator assemblies.

15. The method of claim 14, further comprising treating sewage flow from a gravity-fed urban sewage system in a primary treatment process before discharging the effluent to the effluent channel.

16. The method of claim 14, wherein each of the assemblies further comprises:
a generator located above a high water level of the effluent flow,
a turbine located in the effluent flow and configured for turning around a substantially vertical shaft coupled to and below the generator; and
at least one bearing enclosing a portion of the shaft, the at least one bearing mounted to an upper portion of a channel containing the effluent flow above the high water level, wherein an end of the substantially vertical shaft distal from the generator is unconstrained.

17. The method of claim 16, further comprising feeding power from each of the generator assemblies to a main collection cable.

18. The method of claim 16, further comprising mounting each of the assemblies to an upper portion of a channel via a respective different one of a corresponding group of horizontal braces.

19. The method of claim 16, further comprising configuring the brace in a substantially horizontal configuration.

20. The method of claim 14, further comprising locating the array in the effluent channel having a serpentine configuration.

21. The method of claim 14, wherein an average velocity of the effluent flow in through the effluent channel is at least four times an average velocity of flow through the primary treatment process.

22. The method of claim 14, wherein the effluent flow is treated to a near-final state prior to contacting the array.

23. The method of claim 14, further comprising directing the electricity for use by the wastewater treatment process.
